(19) United States
(12) Patent Application Publication
(10) Pub. No.: US 2007/0127276 A1
(43) Pub. Date: Jun. 7, 2007

(54) Power supply and display

(75) Inventors: Yusaku Yoshimatsu, Kyoto (JP); Takumi Katoh, Kyoto (JP); Yuji Nozasa, Kyoto (JP)

Correspondence Address: CANTOR COLBURN, LLP, 55 GRIFFIN ROAD SOUTH, BLOOMFIELD, CT, 06002, US

(73) Assignee: CYTOMATRIX LLC, CHELMSFORD MASSACHUSETTS, MA (US)

(21) Appl. No.: 10/594,805

(22) PCT Filed: Mar. 30, 2005
(86) PCT No.: PCT/JP05/06046

§ 371 Date: Sep. 28, 2006

(30) Foreign Application Priority Data
Mar. 30, 2004 (JP) 2004-099003

(51) Int. Cl. H02M 1/00

(52) U.S. Cl. 363/49

(57) ABSTRACT

A power supply capable of making soft start efficiently. A power supply (10) is such that the time lag from the soft start trigger representing the start of soft start control to the actual soft start can be decreased by offsetting the potential of a soft start signal from the ground potential. The offset is slightly lower than the minimum potential of a triangular signal. The highest potential level of the soft start signal is preferably lower than the power supply potential.

### TECHNICAL FIELD

This invention relates to a power supply apparatus having a soft-start function and a display apparatus driven by the power supply apparatus.

### BACKGROUND TECHNOLOGY

When a circuit connected to a power supply apparatus is turned on, there are some cases where the inrush current larger than the steady current flows at the output side of the power supply apparatus. The large inrush current possibly heats up the transistors in the internal circuitry and deteriorates the characteristics of the power supply apparatus. Also, the temporary drop in supply potential may adversely affect the operation of circuits other than those in the power supply apparatus. In light of the above, in order to reduce the inrush current at start-up, a power supply apparatus provided with a soft-start function is proposed where the output voltage is gradually increased by gradually increasing the voltage inputted at the start-up (See Patent Document 1, for instance).

[Patent Document 1]

Japanese Patent Application Laid-Open No. 2001-84044.

In the conventional PWM method for the LED drive control, the ratio of time during which the current flowing to LED is turned on and the time during which it is turned off is varied so as to realize DC effective value and control the luminance of LED. In a power supply apparatus that outputs PWM signals as a control signal to supply the power supply, when a soft-start control is performed to reduce the inrush current, the waveform of PWM signal is in the thinned-out state during a soft-start period. As a result, the duty ratio of PWM signal drops by the amount of thinning-out, which leads to the drop in the luminance of LED to which the power supply is fed. Accordingly, it is preferred that the reduction in duty ratio of PWM signal during a soft-start control be restricted as much as possible. As for the power supply apparatus which is not of the PWM method, the input voltage is gradually raised at the soft-start control, so that the time required to reach a desired voltage is naturally longer and thus delayed. And it is preferred that this delay shall be as small as possible.

### DISCLOSURE OF THE INVENTION

The present invention has been made in view of these problems and an object thereof is to provide a power supply apparatus capable of achieving a soft-start control efficiently.

In order to solve the above problems, an embodiment of the present invention relates to a power supply apparatus comprising: an oscillation control circuit which outputs a periodic signal having a predetermined amplitude; a soft-start circuit which outputs a soft-start signal in which potential rises or falls gradually; and a control signal generation circuit which generates a control signal with which to supply power supply, based on potential of the periodic signal generated by said oscillation control circuit and potential of the soft-start signal. In this power supply apparatus, the soft-start circuit has a clamping circuit which offsets the potential of the soft-start signal by a predetermined amount either from ground potential or from supply potential.

The potential of a soft-start signal is offset from either the ground potential or the supply potential, so that the delay, at the performance of a soft-start control, between the start of change in the potential of a soft-start signal till the output of a power supply control signal can be reduced. Thereby, the time required until a desired power has been supplied can be reduced. For example, the loss caused in duty ratio can be made smaller in the control signal generation circuit that outputs PWM signals as the control signal even when the soft-start control is performed, thus realizing the stable power supply by a power supply apparatus.

The periodic signal outputted from the oscillation control circuit is a signal in which the potential changes continuously and periodically with time, and it typically includes a triangular signal and a sawtooth signal and may also include a sinusoidal signal and the like. The soft-start signal may be of a type in which the potential is gradually raised or of a type in which it is gradually lowered. The control signal generation circuit may be structured as a comparator which outputs a comparison result where two inputs have been compared. The type of soft-start signal may be determined based on the relationship with the control signal generation circuit.

It is preferred that the clamping circuit bring, in advance, the potential of the soft-start signal close to a minimum potential or maximum potential of the periodic signal before raising or lowering the soft-start signal. In so doing, the clamping circuit may set, in advance, the potential of the soft-start signal substantially equal to the minimum potential or maximum potential of the periodic signal. When the soft-start signal is of a rising type in the soft-start control, it is preferred that the clamping circuit set the potential of the soft-start signal equal to or slightly smaller than the minimum potential of the periodic signal before the soft-start signal rises. Also, when the soft-start signal is of a falling type, it is preferred that the clamping circuit set the potential of the soft-start signal equal to or slightly higher than the maximum potential of the periodic signal before the soft-start signal falls. The amount of a shift slightly from the minimum potential or maximum potential is preferably on the order of, for example, some fractions of the amplitude of a periodic signal or less. Thereby, it is possible to reduce the time lag between the timing at which the soft-start signal starts to rise or fall till the timing at which the control signal generation circuit outputs the control signal.

Another embodiment of the present invention relates to a display apparatus comprised of a light emitting element and a power supply apparatus for supplying power to the light emitting element. This power supply apparatus includes: an oscillation control circuit which outputs a periodic signal having a predetermined amplitude; a soft-start circuit which outputs a soft-start signal in which potential rises or falls gradually; and a control signal generation circuit which generates a control signal with which to supply power supply to the light emitting element, based on potential of the periodic signal generated by the oscillation control circuit and potential of the soft-start signal, wherein the soft-start circuit has a clamping circuit which offsets the potential of the soft-start signal by a predetermined amount either from ground potential or from supply potential.

In the power supply apparatus the potential of a soft-start signal is offset from either the ground potential or the supply potential, so that at the time when a soft-start control is performed at the start of the light emitting element, the time delay between the start of change in the potential of a soft-start signal till the output of a power supply control signal can be reduced. Thereby, for example, the loss caused in duty ratio can be made smaller in the control signal generation circuit that outputs PWM signals as the control signal even when the soft-start is performed, thus allowing the light emitting element to emit light at luminance substantially equal to the desired brightness.

### BRIEF DESCRIPTION OF THE DRAWINGS

FIG. 1 a schematic diagram showing a basic structure of a power supply apparatus having a soft-start function.

FIG. 2 is a diagram showing relationships between an input signal and an output signal of a comparator in a power supply apparatus.

FIG. 3 shows a structure of a power supply apparatus, having a soft-start function, according to an embodiment of the present invention.

FIG. 4 is a diagram showing relationships between an input signal and an output signal of a comparator in a power supply apparatus according to an embodiment.

FIG. 5 is a block diagram showing a display apparatus utilizing a power supply apparatus according to an embodiment.

### THE BEST MODE FOR CARRYING OUT THE INVENTION

Firstly, a description will be given of a basic structure of a power supply apparatus that achieves a soft-start function.

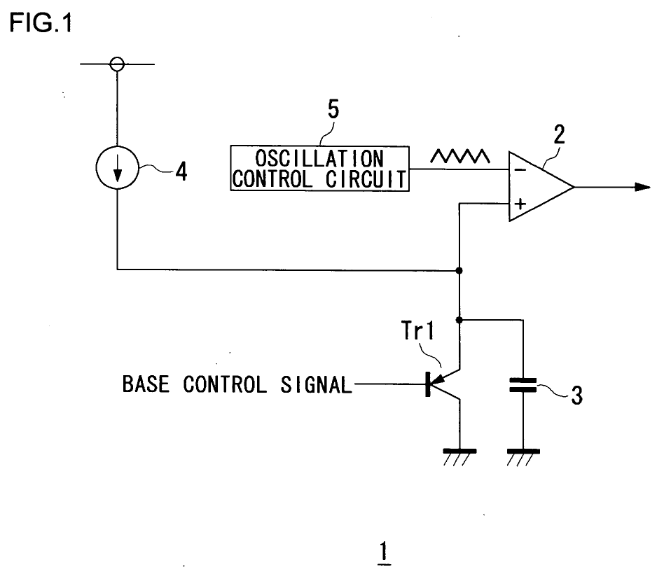

FIG. 1 is a schematic diagram showing a basic structure of a power supply apparatus 1 having a soft-start function. The power supply apparatus 1 is comprised of a comparator 2, a capacitor 3 for soft start, a constant current source 4, an oscillation control circuit 5 and a transistor Tr1 for switching. In the transistor Tr1, a control signal is inputted to the base thereof so as to perform an on-off control thereof. The emitter of the transistor Tr1 is connected to the constant current source 4 and the collector thereof is grounded. The capacitor 3 is provided between the constant current source 4 and the grounding and is connected to a noninverting (+) input terminal of the comparator 2. A triangular signal generated by the oscillator control circuit 5 is inputted to an inverting (−) input terminal of the comparator 2. When the transistor Tr1 is turned on, the potential of the capacitor 3 is in a ground level. When the transistor Tr1 is turned off, the capacitor 3 is charged and the potential gradually rises up to a supply potential level.

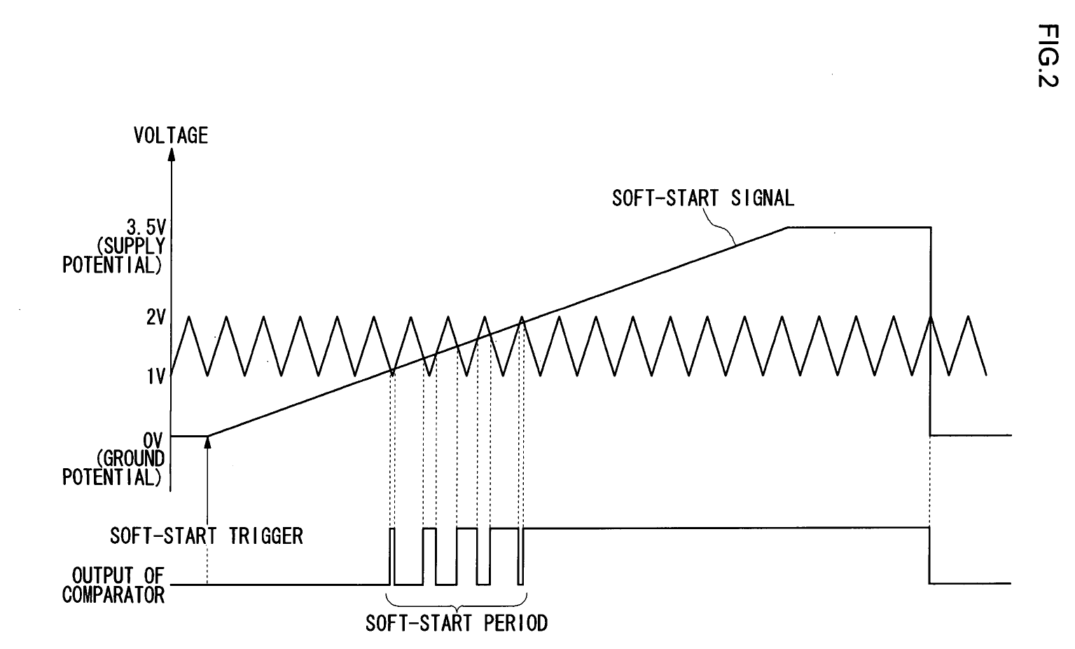

FIG. 2 is a diagram showing relationships between an input signal and an output signal of the comparator 2 in the power supply apparatus 1. More specifically, it shows relationships among a triangular signal inputted to the inverting input terminal of the comparator 2, a soft-start signal inputted to the noninverting input terminal of the comparator 2 from the capacitor 3 and an output of the comparator 2. Preferably, the oscillation control circuit 5 sets the minimum potential of a triangular signal to a voltage higher than 0V so that the output can be stabilized even when either one of inputs to the comparator 2 is the ground potential. If in particular a differential amplifier circuit is to be driven under a low voltage and with high speed, it is required that the oscillation circuit 5 shall set the minimum potential of a triangular signal to a voltage higher than 0V. Under such circumstances, the oscillation circuit 5 sets the minimum potential of a triangular signal to 1V. Note that the oscillation circuit 5 sets the maximum potential to 2V.

When a signal with which to perform a soft-start control is inputted to the transistor Tr1, the transistor Tr1 is turned off and the capacitor 3 is getting charged. This is done by turning the base off with a base control signal. The switching of the transistor Tr1 from ON to OFF is done at the timing indicated as a soft-start trigger in the Figure. When the transistor Tr1 is turned off, the capacitor 3 is charged from the ground potential to the supply potential. The soft start is started at the instant when the amount of charge for the capacitor 3 has reached the minimum potential (1V) of a triangular signal, and the output of the comparator 2 makes the pulse width longer gradually in accordance with the amount of charge. In this manner, the power supply apparatus 1 can achieve the soft start and can reduce the inrush current.

In FIG. 2, the triangle signal changes the potential level linearly and periodically between 1V and 2V. In contrast therewith, the output of the capacitor 3 after the soft-start trigger rises gradually from 0V which is the ground potential up to 3.5V which is the supply potential. Thus, the soft start is not started until the amount of charge for the capacitor 3 has reached the minimum potential of a triangular signal from the ground potential. That is, a time delay is caused between a soft start until the actual start of a soft start. In a case where the power supply apparatus 1 supplies the power to the light source, comprised of LEDs and the like, by the PWM control, this time lag causes to impair the duty ratio of a PWM signal which is an output of the comparator 2.

As indicated as a soft-start period in FIG. 2, the soft-start control results in a state where the PWM signal waveform of a comparator 2 is thinned out, so that the duty ratio of a PWM signal is lower than a desired duty ratio by the thinned-out amount. Hence, the time delay between a soft-start trigger until the start of a soft start is led to further impair the duty ratio of a PWM signal. Hereinbelow, a description will be given of a power supply apparatus where the duty ratio of a control signal outputted from the comparator 2 is brought closer to the desired duty ratio by reducing the delay caused between the soft-start trigger till the start of a soft start.

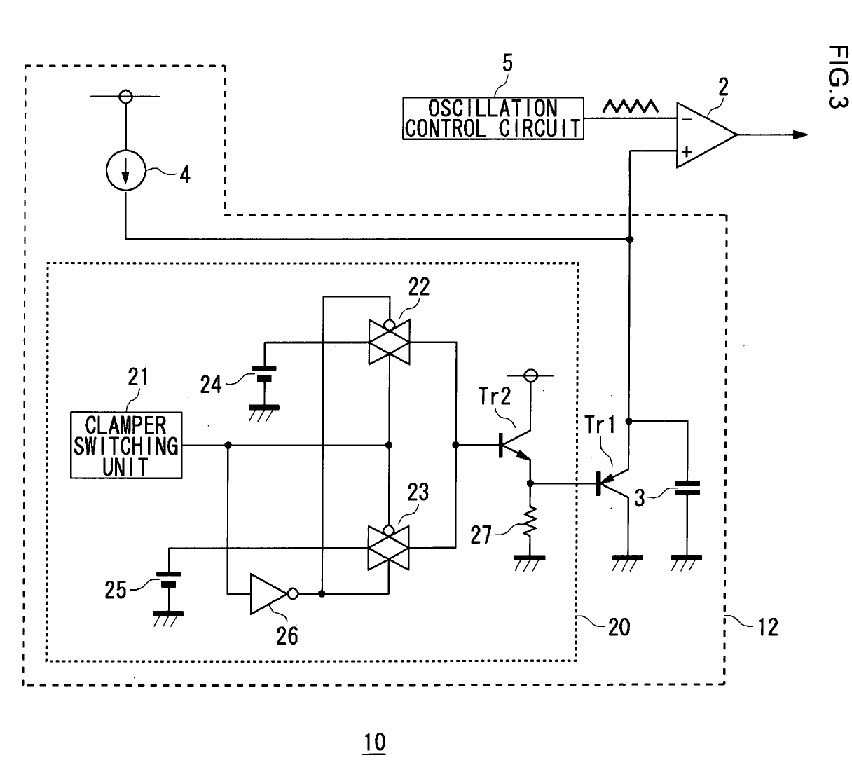

FIG. 3 shows a structure of a power supply apparatus 10, having a soft-start function, according to an embodiment of the present invention. The power supply apparatus 10 is so structured that it is integrally integrated into a single semiconductor substrate. The power supply apparatus 10 is so structured as to contain a soft-start circuit 12 therein. The soft-start circuit 12 according to the present embodiment has a clamping circuit 20, in addition to a capacitor 3 for soft start, a constant current source 4 and a transistor Tr1. The clamping circuit 20 is a voltage retaining circuit comprised of a low damper function to hold a low-voltage level and a high damper function to hold a high-voltage level in the capacitor 3. The clamping circuit 20 sets the upper bound and lower bound to the potential of a soft-start signal and regulates it within a range where the potential of a soft-start signal is greater than the ground potential and less than the supply potential. The clamping circuit 20 offsets the potential of a soft-start signal by a predetermined amount from the ground potential or the supply potential. Note that the damper circuit 20 may have only one of the low damper function and the high damper function, and the damper circuit 20 preferably has at least the low damper function because a soft-start signal that raises the potential is used in the present embodiment. The clamping circuit 20 includes a damper switching unit 21, switches 22 and 23, a high damper setting voltage supply unit 24, a low damper setting voltage supply unit 25, an inverter 26, a resistor 27, and a transistor Tr2. Note that the transistor Tr1 is formed as a bipolar transistor of pnp type and the transistor Tr2 is formed as a bipolar transistor of npn type. Combining the transistor Tr1 and the transistor Tr2 can avoid the temperature dependency of a circuit.

The base of the transistor Tr2 is connected to the switches 22 and 23. The emitter thereof is connected to the base of the transistor Tr1. The collector thereof is connected to the supply potential. The resistor 27 which is grounded is connected between the emitter of the transistor Tr2 and the base of the transistor Tr1. The switch 22 and the switch 23 are switches that each allow the two-way signal transmission upon receipt of two control signals (HIGH and LOW), and are turned on and off based on a damper switching signal supplied from the damper switching unit 21. More specifically, when a HIGH damper switching signal is provided, the switch 22 is turned on and the switch 23 is turned off, thus supplying a predetermined high damper setting voltage from a high damper setting voltage supply unit 24 to the base of the transistor Tr2. On the other hand, when a LOW damper switching signal is provided, the switch 23 is turned on and the switch 22 is turned off, thus supplying a predetermined low damper setting voltage from the low damper setting voltage supply unit 25 to the base of the transistor Tr2. The low damper setting voltage is preferably set to a value slightly less than the minimum potential of a triangular signal. The high damper setting voltage is preferably set to a value greater than the maximum potential of a triangular signal and less than the supply potential.

The emitter of the transistor Tr1 is connected to the constant current source 4 and the collector thereof is grounded. The capacitor 3 is connected to the emitter of the transistor Tr1, is provided between the constant current source 4 and the ground, and is connected to the noninverting (+) input terminal of the comparator 2. When the transistor Tr1 is in the OFF state, the capacitor 3 is charged by the constant current source 4. On the other hand, when the transistor Tr1 is in the ON state, the potential of the capacitor 3 becomes a potential where a forward voltage Vf is added with the base potential of the transistor Tr1. The triangular signal generated by the oscillation control circuit 5 is inputted to the inverting (−) input terminal of the comparator 2.

The transistor Tr2 is turned on when a high damper setting voltage is supplied to the base thereof from the high damper setting voltage supply unit 24. A potential of the emitter in which the high damper setting voltage drops by the forward voltage Vf is supplied to the base of the transistor Tr1. At this time, the transistor Tr1 is in the OFF state, and the capacitor 3 is getting charged by the electric charge supplied from the constant current source 4. When the potential of the capacitor 3 rises to the high damper setting voltage, the transistor Tr1 is turned on and the charging of the capacitor 3 is restricted. The high damper function by the clamping circuit 20 is responsible for an operation in which the potential of the capacitor 3 is prevented from rising to the supply potential. The charging time is dependent on the capacitance of the capacitor 3 and the current of the constant current source 4.

When the damper switching signal is switched from high to low, the low damper setting voltage is supplied from the low damper setting voltage supply unit 25 to the base of the transistor Tr2, and the potential of the emitter in which the low damper setting voltage drops by the forward voltage Vf is supplied to the base of the transistor Tr1. At this time, since the potential of the capacitor 3 is held at a HIGH damper setting voltage value, the transistor Tr1 is turned on and the capacitor 3 releases the charged electric charge until the potential thereof reaches a LOW damper setting voltage value. An operation in which the potential of the capacitor 3 is prevented from falling to the ground potential is controlled by the low damper function of the clamping circuit 20.

In the present embodiment, by employing the low damper function of the clamping circuit 20, the capacitor is charged, in advance, to a value which has been substantially brought closer to the minimum potential of a triangular signal before a soft-start control is started, namely, before the soft-start signal is raised. Hence, the potential of a soft-start signal is brought closer to the minimum potential of a triangular signal. By employing the high damper function of the damper circuit 20, the maximum value of a charging amount is set lower than the supply potential. If a triangular signal outputted from the oscillation control circuit 5 is a periodic signal that varies the potential in between the minimum potential of 1V and the maximum potential of 2V, the low damper setting voltage supply unit 25 will supply the low damper setting voltage so that the voltage value of the capacitor 3 is substantially equal to 1V or slightly lower than 1V in the case when the switch 23 is turned on and the switch 22 is turned off. Where the switch 22 is turned on and the switch 23 is turned off, the high damper setting voltage supply unit 24 will supply the high damper setting voltage so that the voltage value of the capacitor 3 is higher than 2V and lower than the supply potential.

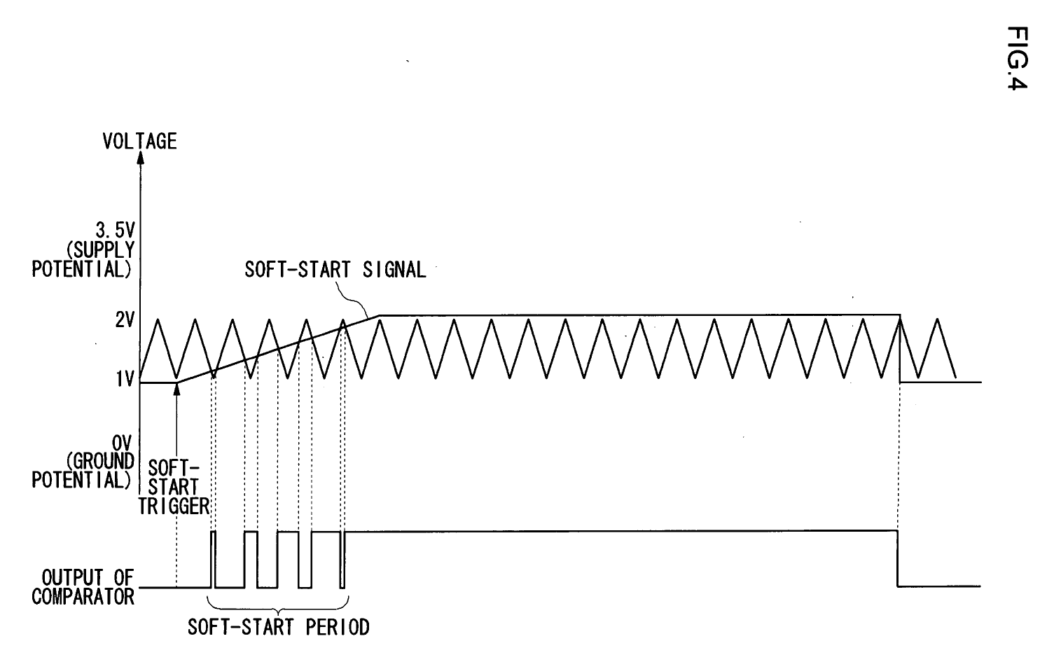

FIG. 4 is a diagram showing relationships between an input signal and an output signal of a comparator 2 in a power supply apparatus 10 according to the present embodiment. More specifically, it shows relationships among a triangular signal inputted to the inverting input terminal of the comparator 2, a soft-start signal inputted to the noninverting input terminal of the comparator 2 from the capacitor 3 and an output of the comparator 2.

Before the start of a soft-start control, the damper switching unit 21 sets the damper switching signal low, and the switch 23 is turned on and the switch 22 is turned off. As a result, the voltage of the capacitor 3 is offset from the ground potential and is set to a value slightly lower than 1V. At the start of a soft-start control, the damper switching unit 21 switches the damper switching signal from low to high. The timing of this switching is indicated as a soft-start trigger in the Figure. When the switch 22 is turned on and the switch 23 is turned off, the capacitor 3 is gradually boosted so as to start the soft start. Since it is boosted from near the minimum potential of a triangular signal, the time lag till the start of a soft start can be reduced. In this manner, the power supply apparatus 10 according to the present embodiment is provided with a low damper function. Hence, the potential of a soft-start signal can be so offset as to reduce the time delay between the timing at which a soft-start signal starts to rise till the timing at which the comparator 2 outputs a control signal. The duty ratio of PWM signal outputted from the comparator 2 is brought closer to a desired value, so that the problem concerning the time lag caused by the soft-start control can be solved.

In a case where the constant current source 4 is made by utilizing a current mirror comprised of bipolar transistors, there will be no current flow passage if the transistor Tr1 is held in the OFF state, so that the constant current source 4 will possibly not operate normally. Particularly when the constant current source 4 is shared by the circuits other than the power supply apparatus 10, the inoperability of the constant current source 4 adversely affects the other circuits sharing it. When the supply potential is applied to the base of the transistor Tr1, the transistor Tr1 will be held in the OFF state.

By implementing the high damper function of a power supply apparatus 10 according to the present embodiments, the transistor Tr1 can be turned on, so that the passage for currents can be secured and the operation of the constant current source 4 can be maintained under the normal condition. In this manner, the clamping circuit 20 restricts the potential of a soft-start signal within a range where it is larger than the ground potential and smaller than the supply potential. Hence, the soft-start can be achieved efficiently and the satisfactory circuit operation can be realized.

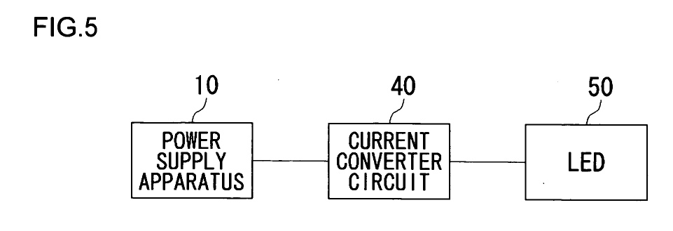

FIG. 5 is a block diagram showing a display apparatus 60 utilizing the power supply apparatus 10 of the present embodiment. The display 60 is an example of electronic equipment utilizing the power supply apparatus 10, and the electronic equipment that enables a speedy soft-start control can be realized by the provision of the power supply apparatus 10 having the soft-start functions. The display apparatus 60 is comprised of a power supply apparatus 10 which supplies the power to a light emitting element, a current converter circuit 40 which converts the voltage to the current and an LED 50 which is a light emitting element. The power supply apparatus 10 generates PWM control signals by which to supply the power, and the current converter circuit 40 converts the PWM control signals to the currents. The LED 50 emits light by a current signal which has been converted. The soft start is so controlled as to reduce the time delay between the soft-start trigger till the generation of PWN control signal. Hence, it is possible to realize a display apparatus 60 that benefits sufficiently from the advantageous aspects of the soft-start control, without lowering the brightness of the LED 50 more than necessary.

The present invention has been described based on the embodiments. These embodiments are merely exemplary and it is understood by those skilled in the art that various modifications to the combination of each component and process thereof are possible and such modifications are also within the scope of the present invention.

In the embodiments, a description has been given of a soft-start signal for which the soft-start is executed by gradually increasing the potential. Conversely, a soft-start signal for which the soft-start is executed by gradually decreasing the potential may be used. In this case, the respective roles of the high damper setting voltage supply unit 24 and the low damper setting voltage supply unit 25 described in the embodiments are reversed. To efficiently achieve the soft start, it is preferred that the high damper setting voltage supply unit 24 shall set the soft-start signal, in advance, to a potential slightly higher than the maximum potential of a triangular signal before lowering the soft-start signal. Thereby, after a soft-start trigger, the soft start is started promptly the same way as in the embodiments.

Though in the embodiments a description has been given of the power supply apparatus 10 using the constant current source 4, a constant voltage source may be used instead of the constant current source 4. In this case, in order to restrict the current, a protective resistor is inserted between the capacitor and the supply potential. A damper circuit realizing the low damper function and the high damper function is provided between the protective resistor and the capacitor, so that the same effect as in the embodiments can be achieved.

### INDUSTRIAL APPLICABILITY

The techniques according to the present invention can be used in the field of power supplies.

What is claimed is:

1. A power supply apparatus, comprising:
an oscillation control circuit which outputs a periodic signal having a predetermined amplitude;
a soft-start circuit which outputs a soft-start signal in which potential rises or falls gradually; and
a control signal generation circuit which generates a control signal with which to supply power supply, based on potential of the periodic signal generated by said oscillation control circuit and potential of the soft-start signal,
wherein said soft-start circuit has a clamping circuit which offsets the potential of the soft-start signal by a predetermined amount either from ground potential or from supply potential.

2. A power supply apparatus according to claim 1, wherein the clamping circuit brings, in advance, the potential of the soft-start signal close to a minimum potential or maximum potential of the periodic signal before raising or lowering the soft-start signal.

3. A power supply apparatus according to claim 2, wherein the clamping circuit sets, in advance, the potential of the soft-start signal substantially equal to the minimum potential or maximum potential of the periodic signal.

4. A power supply apparatus according to claim 2, wherein when the soft-start signal is of a rising type, the clamping circuit sets the potential of the soft-start signal equal to or slightly smaller than the minimum potential of the periodic signal before the soft-start signal rises.

5. A power supply apparatus according to claim 2, wherein when the soft-start signal is of a falling type, the clamping circuit sets the potential of the soft-start signal equal to or slightly higher than the maximum potential of the periodic signal before the soft-start signal falls.

6. A power supply apparatus according to claim 2, wherein the clamping circuit offsets the potential of the soft-start signal so that time delay between the timing at which the soft-start signal stats to rise or fall till the timing at which said control signal generation circuit outputs the control signal is reduced.

7. A power supply apparatus according to claim 1, wherein the clamping circuit regulates the potential of the soft-start signal within a range where it is greater than the ground potential and less than the supply potential.

8. A power supply apparatus according to claim 1, wherein said oscillation control circuits outputs a triangular signal or sawtooth signal.

9. A power supply apparatus according to claim 1, wherein said control signal generation circuit is a comparator which compares the potential of the periodic signal with that of the soft-start signal.

10. A power supply apparatus according to claim 1, wherein said power supply apparatus is integrally integrated on a single semiconductor substrate.

11. An electronic apparatus including a power supply apparatus according to claim 1.

12. A display apparatus comprised of a light emitting element and a power supply apparatus for supplying power to the light emitting element,
said power supply apparatus including:
an oscillation control circuit which outputs a periodic signal having a predetermined amplitude;
a soft-start circuit which outputs a soft-start signal in which potential rises or falls gradually; and
a control signal generation circuit which generates a control signal with which to supply power supply to the light emitting element, based on potential of the periodic signal generated by said oscillation control circuit and potential of the soft-start signal,
wherein the soft-start circuit has a clamping circuit which offsets the potential of the soft-start signal by a predetermined amount either from ground potential or from supply potential.
